(19) United States
(12) Patent Application Publication
(10) Pub. No.: US 2025/0226457 A1
(43) Pub. Date: Jul. 10, 2025

(54) SURFACE TREATED SOLID ELECTROLYTE LAYERS AND BATTERY CELLS THEREOF

(71) Applicant: PolyPlus Battery Company, Berkeley, CA (US)

(72) Inventors: Steven J. Visco, Berkeley, CA (US); Vitaliy Nimon, Berkeley, CA (US); Yevgeniy S. Nimon, Berkeley, CA (US); Bruce D. Katz, Berkeley, CA (US)

(21) Appl. No.: 19/011,330

(22) Filed: Jan. 6, 2025

Related U.S. Application Data
(60) Provisional application No. 63/618,779, filed on Jan. 8, 2024.

(51) Int. Cl. H01M 10/42; H01M 6/04; H01M 6/18; H01M 10/0562; H01M 10/24

(52) U.S. Cl. CPC H01M 10/4235; H01M 6/04; H01M 6/185; H01M 10/0562; H01M 10/24; H01M 2300/0002; H01M 2300/0071; H01M 2300/0088

(57) ABSTRACT

An inorganic ion-conducting membrane treated to modify its surface properties can improve battery cell performance. Membrane surfaces positioned to directly interface with liquid electrolyte(s) on one or both of its major surfaces can be modified to mitigate polarization effects arising from ionic space charges at the solid electrolyte/liquid electrolyte interface when disposed in a battery cell. This surface modification can include fluid treatments that modify the ionic space charge layer to reduce battery cell polarization. The cell polarization can be reduced by at least 10 mV, 50 mV or at least 100 mV as a result of using this surface-modified membrane compared to the same membrane that was not surface-modified.

### CROSS-REFERENCE TO RELATED APPLICATIONS

An Application Data Sheet is filed concurrently with this specification as part of the present application. Any application that the present application claims benefit of or priority to as identified in the concurrently filed Application Data Sheet is incorporated by reference herein in its entirety and for all purposes.

### FIELD OF THE DISCLOSURE

This disclosure generally relates to improving the electrochemical performance of ionically conductive inorganic membranes for use in a battery, and in particular to an improved inorganic Li ion conducting membrane (e.g., a Li ion conductive ceramic membrane) and methods of treating of the ceramic surface to improve electrochemical properties when operated in a battery cell, and to protected electrodes incorporating the instant ceramic membranes, e.g., protected lithium electrodes (PLEs), and to battery cells thereof.

### BACKGROUND

Lithium batteries with high energy density have been developed using Protected Lithium Electrodes (PLEs) to enable advanced battery chemistries, including aqueous lithium batteries, and to enhance both performance and safety. Such PLEs can incorporate a lithium-ion conductive ceramic membrane that serves as a barrier between the anode active material, such as lithium metal, and other components of the battery cell. These components include the electrolyte—whether aqueous or non-aqueous—and the cathode side, which contains the cathode active material.

Previous advancements in this field describe PLE-based batteries that utilize a protective ceramic lithium-ion conductive layer, including some with commonly used materials including lithium-ion conducting phosphates such as lithium aluminum titanium phosphate (LATP). Additionally, garnet-based ceramics and similar materials have been explored as alternatives for the membrane. These configurations effectively isolate lithium metal from contact with reactive battery materials while ensuring efficient ion transport and maintaining the structural and chemical stability of the battery system.

Despite these advancements, challenges remain in improving the electrochemical performance of such batteries. In particular, reducing interfacial polarization and enhancing rate capability are critical areas for further development. This disclosure addresses these challenges by presenting methods and improved components specifically designed to reduce interfacial polarization and to enhance the rate capability of lithium batteries, thereby advancing their practical application and performance.

### SUMMARY

In one aspect, the present disclosure provides an enhanced inorganic ion-conducting membrane for use in a battery cell, wherein the membrane is positioned to directly interface with liquid electrolyte(s) on one or both of its major surfaces. In a specific implementation, the surface of the membrane is modified to mitigate polarization effects arising from ionic space charges at the solid electrolyte/liquid electrolyte interface when disposed in a battery cell. This surface modification includes, for example, treatments that modify the ionic space charge layer to reduce battery cell polarization. In various embodiments the cell polarization is reduced by at least 10 mV, 50 mV or at least 100 mV as a result of using the instant membrane compared to the same membrane that was not surface modified.

In another aspect the present disclosure provides an improved protected electrode (e.g., a PLE) that incorporates the instant inorganic ion-conducting membrane (e.g., LATP membrane) for use in aqueous batteries, wherein an aqueous electrolyte is disposed in direct contact with the membrane and the cathode. In various embodiments the improvement manifests as a reduction in voltage polarization of at least 10 mV the interface between the instant membrane and a liquid electrolyte employed in the protected electrode. The reduction in voltage polarization at the interface can be at least 50 mV, or at least 100 mV. For instance, in one embodiment a non-aqueous liquid electrolyte is employed in the PLE and the reduction in voltage polarization at the non-aqueous liquid electrolyte/solid electrolyte membrane interface is reduced by at least 10 mV, or at least 50 mV, or at least 100 mV when compared to a PLE that uses the same solid electrolyte membrane that has not been surface modified.

In yet another aspect the present disclosure provides a battery that incorporates the instant inorganic ion-conducting membrane, and thus yields improved performance such as reduced cell voltage polarization. In various embodiments the battery is rechargeable. In other embodiments it is a primary battery. In various embodiments (rechargeable or primary), the instant battery is a lithium battery (e.g., a Li-Water battery, a Li-Air battery, or an aqueous Li—S battery). In various embodiments the cell polarization is reduced by at least 10 mV, 50 mV or at least 100 mV as a result of using the instant membrane compared to the same membrane that was not surface modified.

In another aspect, the present disclosure provides a battery and/or a protected electrode with enhanced electrochemical performance. This improvement is achieved by inducing charged species to adsorb onto the surface of the solid electrolyte through adjustments to the composition of the liquid electrolyte(s) interfacing with one or both major surfaces of the ceramic membrane. In various embodiments the battery cell polarization is reduced by at least 10 mV, 50 mV or at least 100 mV as a result of using the instant membrane compared to the same membrane that was not surface modified.

In various aspects the present disclosure provides methods of treating or modifying the surface of a solid inorganic electrolyte membrane that reduces voltage polarization when incorporated in a protected electrode or battery cell.

In one aspect the method involves treating the membrane prior to incorporation into a protected electrode or battery cell. In various embodiments the method involves treating the membrane surfaces with gaseous/vapor or liquid phase species. In various embodiments the treatment leads to making the membrane surface more negatively charged, as a result of anion adsorption. For instance, in a particular embodiment the electrical charge of the solid electrolyte membrane surface is altered by adsorption of anions (e.g., hydroxyl anions), thereby making the solid electrolyte membrane surface more negatively charged as a result of the adsorption. In some embodiments the surface is made more positively charged by the treatment. For instance, by first adsorbing anion species onto the surface (e.g., hydroxyl anions) and then desorbing the anions, thereby making the solid electrolyte membrane surface more positive. The membrane has two major opposing surfaces, and in some embodiments one or both surfaces are treated. For instance, one surface treated to be more positive or negatively charged, or both surfaces treated to have the same charge, or one surface treated to have an electrical charge that is positive, and the other surface treated to achieve a negative charge.

In various embodiments a method of treating an ion conductive solid electrolyte membrane is described that effectuates lower battery cell polarization when incorporated as an electrolyte in a battery cell, the method comprising the steps of providing the membrane having first and second major surfaces and exposing one or both surfaces to a liquid or vapor phase treating fluid that modifies the electrical charge of the membrane surface. The exposing step is ex-situ, meaning it takes place outside of the battery cell into which the membrane is intended to be incorporated, and the treating fluid is not a battery electrolyte or a component of the battery cell. In various embodiments the treating fluid is aqueous. For instance, the treating fluid comprises water and leads to adsorption of anionic species onto the first and/or second major surfaces of the membrane. In various embodiments the adsorbed anions are hydroxyl ions. In some embodiments, the electrical charge on the treated membrane surface is further modified by first adsorbing the anions (e.g., hydroxyl ions) and then desorbing the anions (e.g., using UVOC or plasma treatment). Once desorbed, to avoid re-adsorption of hydroxyl ions, the membrane is kept/stored in a dry inert environment such as dry argon, dry helium, or dry air (e.g., dry air) prior to incorporation into the battery cell.

In another aspect the method involves adjusting the liquid electrolyte composition that interfaces with the solid electrolyte membrane to effectuate adsorption of ionically charges species that modifies the ionic space charge layer (e.g., reduces its thickness) and leads to reduced cell polarization. In various embodiments the method involves additives incorporated into the liquid electrolyte that lead to a reduction in battery cell polarization compared to the same cell without the incorporation of the electrolyte additive. In accordance with this aspect of the invention, suitable additives comprise adsorbing ionic species that adsorb onto the membrane surface in direct contact with the liquid electrolyte. As a result of adsorption, the voltage polarization can be reduced by at least 10 mV, or at least 50 mV or at least 100 mV. In various embodiments the adsorbing species are anionic, and in other embodiments the species adsorbed on the membrane surface are cationic. In a particular embodiments, the adsorbing species are iodine anions. In another particular embodiment the adsorbing species are tetraalkylammonium cations.

### BRIEF DESCRIPTION OF THE DRAWINGS

FIG. 1 illustrates in cross section a solid electrolyte membrane, protected electrode and battery cell each in accordance with embodiments of the present disclosure.

### DETAILED DESCRIPTION

Reference will now be made in detail to specific embodiments of the disclosure. Examples of the specific embodiments are illustrated in the accompanying drawings. While the disclosure will be described in conjunction with these specific embodiments, it will be understood that it is not intended to limit the disclosure to such specific embodiments. On the contrary, it is intended to cover alternatives, modifications, and equivalents as may be included within the spirit and scope of the disclosure as defined by the appended claims. In the following description, numerous specific details are set forth in order to provide a thorough understanding of the present disclosure. Embodiments of the present disclosure may be practiced without some or all of these specific details. In other instances, well known process operations have not been described in detail in order not to unnecessarily obscure the present disclosure.

When used in combination with “comprising,” “a method comprising,” “a device comprising” or similar language in this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

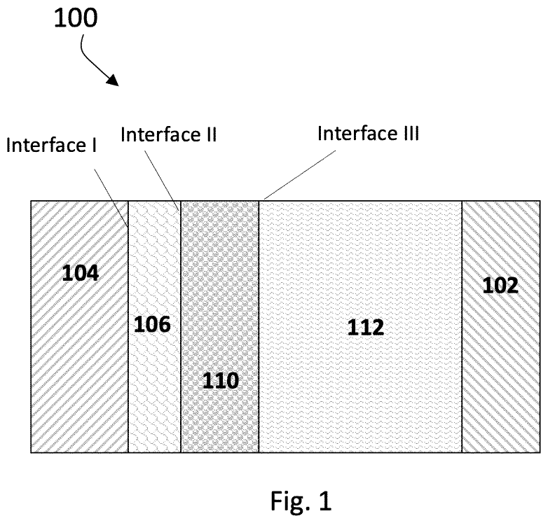

With reference to FIG. 1 a battery cell 100i is illustrated in cross section in accordance with various embodiments of the present disclosure. Battery cell 100 includes cathode (positive electrode) 102, anode (negative electrode) 104, solid electrolyte membrane 110 (e.g., LATP) with first and second major surfaces, liquid electrolyte (catholyte) 112 disposed in direct contact with cathode 102 and membrane 110, and liquid electrolyte (anolyte) 106 in direct contact with the anode and the membrane second major surface. In various embodiments battery cell 100 may include only one liquid electrolyte. For instance, battery cell 100 may not include anolyte 106 or it may not include catholyte 106. In such instances, the cathode side of the cell may be fully solid-state (when the catholyte is not employed), or when an anolyte is not employed, the membrane first surface directly contacts the electroactive material of the anode (e.g., Li metal).

Battery cell 100 may function as either a primary or secondary battery. In various embodiments, the anode is a lithium-based anode, such as lithiated carbon (e.g., graphite) or lithium metal. The catholyte may be aqueous, while the anolyte is a non-aqueous aprotic electrolyte. Battery cell 100 may take the form of a Li-water battery, a Li-sulfur battery, a Li-air battery, or, in specific embodiments, an aqueous Li-sulfur battery. Such battery cells incorporating a solid electrolyte membrane are described in detail, for example, in various U.S. patent publications, including U.S. Pat. Nos. 9,287,573 and 10,164,289, and U.S. Patent Publication No. US-2024-0363895 and US-2025-0006984. These prior patent publications of the applicant are hereby incorporated by reference for their disclosures of battery cell configurations and compositions to facilitate understanding of this disclosure. In accordance with the present disclosure, the solid electrolyte membrane, along with the methods and liquid electrolytes described herein, may be utilized as a solid electrolyte membrane in the aforementioned battery cells.

In accordance with the present disclosure, the first or second major surface of membrane 110 undergoes surface treatment. In various embodiments, the surface treatment is performed prior to the membrane's incorporation into the battery cell. For example, a treating fluid in either liquid phase or vapor phase may be applied to the surface. In some embodiments, the treating fluid is liquid water or water molecules in a liquid or vapor phase. Importantly, the treating fluid used in these embodiments is distinct from the battery cell's electrolyte, and is not a battery cell electrolyte, or is not intended to be used as a battery cell electrolyte. In other embodiments, the membrane surface is treated after its incorporation into the battery cell by exposure to the liquid electrolyte, such as the liquid catholyte or liquid anolyte.

Solid electrolyte membrane 110 is inorganic, in whole or in part, comprising a solid inorganic electrolyte material. A variety of solid electrolyte materials may be employed, with polycrystalline ceramic ion conductors, such as ceramic Li-ion conductors, being particularly suitable. One example of such a material is lithium aluminum titanium phosphate (LATP), a solid electrolyte with a crystalline structure that provides ionic conductivity primarily through Li-ion transport. LATP typically consists of lithium ions (Li), aluminum (Al), titanium (Ti), and phosphate (PO₄) groups, forming a robust, stable framework. Due to its relatively low concentration of mobile Li ions, LATP is susceptible to space charge accumulation at the interface between the membrane and the adjacent liquid electrolyte-whether the liquid anolyte or catholyte-when in direct, touching contact. This space charge accumulation can adversely affect the overall ionic transport efficiency and performance of the membrane in the battery cell

Continuing with reference to FIG. 1, in various embodiments anolyte 106 is a non-aqueous liquid electrolyte and catholyte 112 is an aqueous solution. The PLE rate capability depends on polarizations associated with three interfaces: Li/non-aqueous electrolyte (interface I), non-aqueous electrolyte/solid electrolyte membrane (interface II), solid electrolyte membrane/aqueous electrolyte (interface III), as well as iR drops across the non-aqueous electrolyte interlayer and the solid electrolyte membrane. The iR drops can be reduced significantly by reducing the thicknesses of the non-aqueous electrolyte interlayer and the solid electrolyte membrane. In most cell configurations, the polarizations of the interfaces II and III either contribute significantly or outright dominate the overall PLE polarization. The present disclosure addresses methods, materials, and material components for reducing polarizations at interfaces II and III, thus enhancing the PLE rate capability.

Under equilibrium conditions, ionic space charge layers form near the liquid electrolyte/solid electrolyte interfaces in non-aqueous and aqueous liquid electrolytes as well as in the solid electrolyte. In liquid electrolytes, the ionic space charge layers are described by the conventional Gouy-Chapman model and for concentrated solutions used in batteries they have a thickness of a few angstroms. In solid electrolytes, such as LATP, the thickness of an ionic space charge layer is much greater due to lower concentration of ionic charge carriers (Li cations), the immobility of anions in the crystal lattice, and high dielectric constant values of solid electrolytes. The presence of ionic space charge layers in the solid electrolyte membrane near the interfaces with liquid electrolytes significantly affects the transport of Li cations.

Disclosed herein below are methods for modifying the charge of the solid electrolyte membrane surface making it more positive or more negative during battery charge and discharge, including:

In various embodiments the present disclosure provides ex situ treatment of the solid electrolyte membrane surface in gaseous or liquid media.

In one embodiment, the electrical charge of the solid electrolyte membrane surface is altered by adsorption of anions (e.g., hydroxyl anions), thereby making the solid electrolyte membrane surface more negatively charged as a result of the adsorption. If such anionic groups are present on the surface, their desorption makes the solid electrolyte membrane surface more positive. The presence of hydroxyl anions on the surface can be observed with IR spectroscopy. Exposure to wet atmosphere creates such surface groups and their removal is achieved with UVOC or plasma treatment. Once the hydroxyl surface groups are removed, the surface character can be preserved by only exposing the membrane to dry inert atmosphere prior to building a Li/water cell.

In some embodiments, one surface of the solid electrolyte membrane contains adsorbed hydroxyl groups and the other surface does not. In some particular embodiments, inhibition of hydroxyl group adsorption on the solid electrolyte membrane surface can be achieved by a pre-treatment that results in adsorption of organic molecules from the gas phase.

In various embodiments, an in-situ treatment of the solid electrolyte membrane surface is performed such as for a Li/water cell.

Composition of a solid electrolyte membrane surface as well as ionic space charge distribution near the surface can be modified by interaction with components of aqueous and/or non-aqueous liquid electrolyte. Both the interfacial charge transfer and the Li cation transport in solid electrolyte near its surface depend on liquid electrolyte composition. Accordingly, in various embodiments inorganic and/or organic species dissolved in liquid aqueous and non-aqueous electrolytes can be used for specific adsorption on the solid electrolyte membrane surface to affect its electrical properties.

In one embodiment iodine anions are added to the liquid electrolyte as the adsorbing ion. Specific adsorption of iodine anions at the interface II gives the ceramic surface additional negative charge. A suitable non-aqueous electrolyte for the purpose can contain 0.05 M-0.5 M of LiI dissolved in aprotic solvent(s) in addition to the main electrolyte salt.

In another embodiment, tetraalkylammonium salts may be used, in particular tetrabutylammonium salts, as additives to either non-aqueous electrolyte or aqueous electrolyte, or both. Concentrations of added tetraalkylammonium salts in a suitable electrolyte for the purpose can be in the range 0.05 M-0.5 M, for example. Specific adsorption of tetraalkylammonium cations [H(CH₂)ₙ]₄N⁺ gives the ceramic surface additional positive charge. In one particular embodiment, tetrabutylammonium salts can be used as additives to non-aqueous electrolyte.

In yet another embodiment, tetraalkylammonium salts may be added to an aqueous electrolyte in order to protect the solid electrolyte membrane (e.g., LATP) surface from reaction with concentrated base that forms on deep discharge, since at high concentrations tetraalkylammonium cations can form condensed surface films.

1. A method of treating an ion conductive solid electrolyte membrane to effectuate lower battery cell polarization when incorporated as an electrolyte in a battery cell, the method comprising: providing an ion conductive solid electrolyte membrane having first and second major surfaces; modifying the electrical charge of one or both of the surfaces by exposure to a liquid or vapor phase treating fluid; such that the modifying results in lower polarization of the battery cell relative to the same battery cell that uses the same solid electrolyte membrane that has not been surface modified.

2. The method of claim 1 wherein the exposing takes place outside of the battery cell into which the membrane is intended to be incorporated, and the treating fluid is not a battery electrolyte or a component of the battery cell.

3. The method of claim 1 wherein the treating fluid is aqueous.

4. The method of claim 3 wherein the treating fluid comprises water and leads to adsorption of anionic species onto the first and/or second major surface.

5. The method of claim 4 wherein the anionic species adsorbed on the membrane surface are hydroxyl anions.

6. The method of claim 4 further comprising the step of desorbing the anionic species from the surface prior to incorporating the membrane into the battery cell.

7. The method of claim 6 wherein the desorbing step comprises one or both exposing the treated membrane surface to a subsequent ozone or plasma desorption treatment.

8. The method of claim 7 wherein subsequent to the desorption treatment the membrane is not exposed to moist air and stored in a dry inert environment prior to incorporation into the battery cell.

9. A protected electrode comprising the treated membrane as recited in claim 1.

10. A battery cell comprising the treated membrane as recited in claim 1.

11. A battery cell comprising a solid electrolyte membrane and a liquid electrolyte, wherein the solid electrolyte membrane and liquid electrolyte directly interface, and the liquid electrolyte comprises an ionic species that adsorbs onto the membrane surface in direct contact with the liquid electrolyte, wherein the polarization of the battery cell is reduced by at least 10 m V compared to the same battery cell absent of the adsorbing ionic species.

12. The battery cell of claim 11 wherein the adsorbing ionic species are negatively charged anions.

13. The battery cell of claim 12 wherein the adsorbing species are iodine anions.

14. The battery cell of claim 11 wherein the adsorbing ionic species are positively charged cations.

15. The battery cell of claim 14 wherein the adsorbing species are tetraalkylammonium cations.
